(19) United States
(12) Patent Application Publication
(10) Pub. No.: US 2026/0370583 A1
(43) Pub. Date: Nov. 19, 2026

(54) Debugging Packet Spraying Networks

(71) Applicant: Cisco Technology, Inc., San Jose, CA (US)

(72) Inventors: Ayan Banerjee, Fremont, CA (US); Venkata Naga Ramesh Ponnapalli, Sunnyvale, CA (US); Melvin Tsai, Palo Alto, CA (US)

(21) Appl. No.: 19/210,969

(22) Filed: May 16, 2025

(51) Int. Cl. H04L 43/0829

(52) U.S. Cl. CPC H04L 43/0829

(57) ABSTRACT

In one embodiment, determining packet loss may comprise a method of determining a segment of a data network for monitoring packet loss. This is followed by monitoring the segment, marking a plurality of packets of a data flow within the segment, receiving count data associated with one or more packets traversing within the segment, identifying mismatches within the count data, and making a packet loss determination based at least in part on the identified mismatch.

The present disclosure relates to network communication. More particularly, the present disclosure relates to debugging packet loss within packet spraying networks.

### BACKGROUND

Modern data networks continue to experience significant growth in scale and complexity, driven by the escalating demands of distributed applications, cloud computing services, and large-scale data analytics. In particular, the rise of Artificial Intelligence (AI) and Machine Learning (ML) workloads has placed unprecedented requirements on network infrastructure, necessitating extremely high bandwidth, low latency, and non-blocking or near non-blocking performance characteristics to interconnect vast numbers of computational resources, such as Graphics Processing Units (GPUs). Consequently, network architectures within large data centers have evolved towards highly interconnected fabric designs capable of supporting these intensive communication patterns and scaling to accommodate tens or even hundreds of thousands of endpoints.

To meet these scalability and performance goals, network fabrics often employ multi-tiered topologies, such as spine-leaf or folded Clos architectures. These designs can provide high bisection bandwidth, allowing for efficient communication between any two points in the network, and typically offer multiple parallel paths between source and destination endpoints. Networking protocols and techniques, including variations of Equal-Cost Multi-Path (ECMP) routing or more dynamic load distribution methods, may be utilized to spread traffic across these available paths. Distributing traffic in this manner can potentially improve overall network utilization and application performance by preventing congestion on any single path, but it also increases the complexity of traffic flow patterns within the fabric.

The management and troubleshooting of these large, intricate network fabrics present considerable challenges for network operators. Diagnosing performance issues, especially subtle or intermittent problems like packet loss, becomes significantly more difficult when data flows are dynamically distributed across numerous potential physical routes through the network. Traditional diagnostic tools and techniques may struggle to provide adequate visibility or pinpoint the exact location of failures or bottlenecks within such complex, high-speed environments. There remains a general need within the field for effective and scalable methods to monitor network health, detect anomalies, and accurately isolate the root causes of packet loss or performance degradation in modern multi-path network fabrics without significantly disrupting ongoing network operations.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric, in accordance with various embodiments of the disclosure;

FIG. 2 is a conceptual network diagram of various environments that a packet debugging logic may operate, in accordance with various embodiments of the disclosure;

FIG. 3 is a schematic diagram of an exemplary network path through a multi-stage fabric, in accordance with various embodiments;

FIG. 4 is a schematic diagram of a large-scale network fabric architecture, which may incorporate packet debugging logic, in accordance with various embodiments;

FIG. 5 is a flowchart showing a high-level process for identifying potential packet loss, in accordance with various embodiments;

FIG. 6 is a flowchart illustrating a process for network analysis and remediation, in accordance with various embodiments;

FIG. 7 is a flowchart depicting a process for generating a charging instruction signal, in accordance with various embodiments of the disclosure;

FIG. 8 is a flowchart illustrating a process for packet monitoring and data reporting; and

FIG. 9 is a conceptual block diagram of a device suitable for configuration with a packet debugging logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DESCRIPTION OF EXAMPLE EMBODIMENTS

### Overview

In some embodiments, a method can include determining one or more device characteristics of a plurality of ambient power devices, identifying a set of overlapping ambient power devices of the plurality of ambient power devices in communication with a wireless device, and transmitting, to the wireless device, a charging instruction signal based on the one or more device characteristics.

In a number of embodiments, a device can include a processor, a memory communicatively coupled to the processor, and a transmission scheduling logic. The logic can be configured to detect one or more ambient power devices, determine one or more device characteristics of the one or more ambient power devices, generate one or more charging frames based on the one or more device characteristics, and transmit the one or more charging frames to the one or more ambient power devices.

### Example Embodiments

In response to the issues described above, embodiments described herein can provide systems, methods, and devices for diagnosing packet loss within complex network fabrics using targeted monitoring and analysis techniques. These approaches may allow for the identification and localization of packet drops, particularly in large-scale, multi-path environments such as those employing spine-leaf architectures and packet spraying, without necessarily requiring deep packet inspection across the entire network or mandating significant modifications to existing network hardware capabilities. The general principle involves selectively marking packets belonging to a specific data flow of interest for a defined duration, enabling network devices along the potential paths of that flow to count these specific packets, and subsequently analyzing the collected counts to pinpoint inconsistencies indicative of loss.

In various embodiments, the process can commence with the identification of a data flow and a segment of the network for monitoring. A suitable packet marking technique may then be determined, potentially involving the modification of specific, often reserved, bits or fields within the headers of the packets belonging to the selected data flow. This marking operation can be initiated at an ingress point to the monitored network segment and may persist only for a defined observation period, perhaps controlled by logical start and stop signals or timers managed by a controlling entity, such as packet debugging logic. This time-bounded marking creates a distinct cohort of packets associated with the flow under investigation, allowing these packets to be uniquely tracked as they traverse the multiple paths potentially available within the network fabric.

In many embodiments, concurrently with the marking, network nodes within the monitored segment, such as switches or routers, can be configured to perform statistic collection focused specifically on these marked packets. These nodes may count the marked packets as they arrive on incoming interfaces and as they depart on outgoing interfaces during the observation period, generating ingress and egress count data. Configuration mechanisms like Access Control Lists (ACLs) or specialized flow monitoring functions might be employed to facilitate this counting in hardware. After the observation period concludes, this distributed count data can be received or collected by a central logic or system, which then evaluates and analyzes the counts. By comparing ingress and egress counts at each monitored node, or by correlating counts between adjacent nodes, mismatches can be identified, allowing for the determination of the specific node(s) or link(s) responsible for packet loss experienced by the data flow.

A network fabric can be understood as an architectural approach to designing and managing network infrastructure. Instead of viewing the network as a collection of discrete devices managed individually, a fabric architecture may allow administrators to see and manage the entire network system as a single, cohesive entity. This approach often emphasizes high degrees of interconnection between network nodes, potentially creating numerous paths for data traffic. The goal here can be to simplify overall network operations and enable more agile, flexible, and scalable connectivity compared to some traditional designs.

In contrast to older, multi-tiered hierarchical network models like the traditional core-aggregation-access design, a network fabric might often present a flatter network topology. One very common implementation seen in modern data centers, which can be considered a type of fabric, is the Leaf-Spine architecture. In such a setup, Leaf switches might connect directly to endpoints like servers or storage, while Spine switches can serve primarily to interconnect all the Leaf switches. This arrangement may mean that traffic between any two endpoints within the fabric potentially only needs to traverse its originating Leaf switch, one Spine switch, and the destination Leaf switch. This structure can significantly reduce the number of hops and associated latency for traffic flow within the fabric and may help provide more predictable performance and higher overall bandwidth between any two points compared to legacy designs where traffic might have had to ascend and descend a deeper hierarchy, possibly encountering bottlenecks along the way.

The characteristics commonly associated with network fabrics can make them particularly well-suited for the intense demands often found in AI networking. Training large AI models, for instance, frequently involves distributed computing tasks spread across a vast number of specialized processors, like GPUs, which may need to communicate extensively and frequently with each other. This can result in complex, high-bandwidth, many-to-many communication patterns that might overwhelm traditional network designs. A well-architected network fabric, potentially utilizing high-speed technologies like Ethernet with RoCE (RDMA over Converged Ethernet) or InfiniBand, can offer the very low latency and high cross-sectional bandwidth that may be needed to sustain these demanding communication patterns. By potentially minimizing network bottlenecks and ensuring efficient data exchange between processing units, a fabric network might help keep expensive AI accelerators highly utilized, possibly accelerating the overall model training process.

Furthermore, the conceptualization of the network as a unified fabric may also lend itself well to advanced management and automation techniques. Treating the collection of switches as a single logical system can potentially simplify tasks such as configuration deployment, policy enforcement, monitoring, and troubleshooting across the entire network infrastructure. This centralized or unified management plane could be especially advantageous in the large, dynamic environments typical of AI clusters, where network agility and reliability might be paramount to supporting the underlying computational workloads effectively. The goal of a fabric, therefore, can be seen as providing a robust, scalable, and manageable network foundation that may be optimized for high-performance communication.

A Graphics Processing Unit, or GPU, initially designed for rendering complex visuals in gaming and video, possesses an architecture that may allow it to perform a massive number of relatively simple calculations simultaneously. This parallel processing capability has proven exceptionally effective for the types of mathematical operations, such as matrix and vector computations, that are fundamental to many artificial intelligence algorithms, especially within deep learning. Consequently, GPUs can often accelerate AI computations far beyond what might be achievable with traditional CPUs alone.

A GPU cluster, therefore, can be understood as a collection of interconnected computer systems, typically high-performance servers, where each system, or node, might be equipped with one or multiple powerful GPUs. These individual nodes are linked together using a very high-speed network fabric. The core idea behind creating such a cluster is to aggregate the substantial parallel processing power of potentially hundreds or even thousands of GPUs. This collective power may then be harnessed to tackle extremely large-scale computational problems, particularly those encountered in advanced AI research and development, which might be too time-consuming or computationally infeasible for a single system or a smaller number of GPUs to handle effectively.

In the context of AI networks, GPU clusters can form the computational heartland for demanding tasks like training sophisticated deep learning models. Training these models often involves feeding them enormous datasets and performing countless iterative calculations to adjust model parameters. A GPU cluster might dramatically accelerate this process by distributing the workload across its many processing units, allowing different parts of the computation or dataset to be processed in parallel. This parallelization can significantly reduce the time required to train complex models, potentially shrinking training cycles from weeks or months down to days or even hours. Such acceleration may enable faster experimentation, development of more complex models, and quicker deployment of AI solutions. Beyond training, these clusters might also be employed for large-scale AI inference, where trained models need to process incoming data streams rapidly.

The performance and efficiency of a GPU cluster, however, may depend critically not just on the computational prowess of the GPUs themselves, but also on the network that interconnects them. During distributed AI tasks, the GPUs frequently need to exchange substantial amounts of data with each other at very high speeds-this might include sharing intermediate results, synchronizing model parameters, or accessing distributed datasets. Therefore, a high-bandwidth, extremely low-latency network, often architected as a specialized network fabric using technologies like InfiniBand or Ethernet enhanced with RDMA capabilities (RoCE), can be essential. An inadequate or congested network could potentially become a significant bottleneck, forcing expensive GPUs to sit idle while waiting for data, thereby undermining the cluster's overall performance and negating much of the benefit of having such powerful parallel processing capabilities available. Consequently, the network design may be considered just as crucial as the compute elements within a high-performing GPU cluster intended for AI workloads.

Packet spraying can be understood as a network traffic distribution strategy sometimes employed in high-performance environments, potentially including networks designed for demanding artificial intelligence workloads. Instead of strictly assigning all data packets belonging to a single communication flow (like a large data transfer between two servers) to one specific path, packet spraying techniques may distribute individual packets, or small bursts of packets, from that flow across multiple available network links or paths. This approach might be seen as a form of dynamic load balancing operating at a very granular level, potentially aiming to achieve more uniform utilization across the network fabric compared to methods that consistently map entire flows to single paths based on header information. The fundamental idea is that by spreading the load more evenly on a packet-by-packet basis, the system might avoid congestion points and possibly leverage the aggregate bandwidth of parallel paths more effectively.

In the context of large-scale AI networks, such as those supporting distributed training clusters with numerous GPUs or accelerators, this technique may offer particular advantages. AI training frequently involves massive, synchronized data exchanges between compute nodes, like the transfer of model parameters or gradients during operations such as All-Reduce. These operations can generate substantial, often bursty, network traffic. Traditional load balancing based on flow hashing might inadvertently direct a very large, performance-critical flow onto a single link, potentially creating a bottleneck even if other links have available capacity. Packet spraying, in contrast, can allow such large flows to be broken down and spread across many paths simultaneously. This dispersal might help prevent individual link saturation and could potentially reduce the overall completion time for these critical communication phases, thereby possibly accelerating the entire AI training job. The goal may be to ensure that the expensive compute resources are not kept waiting unnecessarily due to network constraints.

However, implementing and utilizing packet spraying might also introduce certain complexities. When packets belonging to the same original flow travel across different network paths, they can experience varying amounts of delay. This can lead to the packets arriving at the destination out of their original sequence order. While network protocols like TCP are designed to handle some level of packet reordering, excessive or highly variable reordering, which might result from aggressive packet spraying across paths with significantly different latencies, could potentially challenge standard TCP mechanisms. This situation might sometimes lead to reduced throughput or increased processing overhead at the receiver as it works to reassemble the original data stream. Consequently, networks employing packet spraying may benefit from transport protocols or application-level logic specifically designed or tuned to cope with higher degrees of packet reordering. The logic managing the spraying process itself also needs careful design to ensure fair and efficient distribution without introducing undue overhead or unintended consequences.

In networking, data is typically broken down into smaller units called packets for transmission across the network infrastructure. Packet loss can be said to occur when one or more of these packets fail to arrive at their intended destination. This failure might happen for various reasons; for example, network devices like switches or routers may discard packets if their internal buffers become full due to congestion. Faulty network hardware, errors in device software, interference on wireless links, or corruption of data during transmission over physical cables could also potentially lead to packets being dropped or becoming unrecognizable.

The consequences of packet loss can vary depending on the application and the protocols being used, but it generally degrades network performance. For connection-oriented protocols such as TCP, which is widely used for reliable data transfer, mechanisms exist to detect lost packets. Upon detection, the sender typically retransmits the missing packets to ensure the complete data set arrives correctly. While this ensures reliability, the retransmission process itself can consume additional network bandwidth and, perhaps more significantly, may introduce noticeable delays, often referred to as latency, and variations in delay, known as jitter. Applications sensitive to these factors, like real-time communication or tightly coupled distributed systems, might experience significant performance degradation, potentially manifesting as slow responsiveness or session instability, even with relatively low levels of packet loss. Other protocols, like UDP, might not employ retransmission, meaning loss simply results in missing data at the application layer.

In the specialized domain of AI networks, particularly those supporting large GPU clusters for training or inference, the impact of packet loss can be especially severe. These environments often rely on extremely high-speed, low-latency communication between numerous processing nodes. Distributed AI workloads frequently involve intricate communication patterns where nodes must exchange large volumes of data rapidly and synchronously. Packet loss in this context, even at seemingly low rates, might disrupt these sensitive communication flows. Protocols often used in these settings, such as those enabling Remote Direct Memory Access (RDMA), can be particularly susceptible to performance degradation caused by loss. Lost packets might lead to stalled computations, significantly increased time to complete AI training jobs, and an overall reduction in the efficiency of the expensive GPU cluster, as processing units may end up waiting idly for missing data or retransmissions.

The term packet spraying often relates to load balancing techniques used in modern network fabrics, such as Equal-Cost Multi-Path (ECMP) routing commonly found in Leaf-Spine architectures. ECMP allows a network device to distribute outgoing traffic destined for a particular endpoint across multiple available network paths that have the same “cost” or preference. This spraying or distribution of traffic flows can help utilize network bandwidth more effectively and may improve resilience by providing path redundancy. However, packet loss can still occur within environments employing packet spraying. If one of the specific paths chosen for spraying traffic experiences congestion or errors resulting in packet loss, the flows assigned to that problematic path will suffer the consequences. While ECMP aims to distribute load, it doesn't inherently eliminate the underlying causes of packet loss on any individual path. Therefore, even within a sophisticated AI network fabric using packet spraying, careful monitoring for packet loss across all potential paths and implementing strategies to mitigate its causes and effects may remain critical to ensure the consistent high performance required for demanding AI workloads.

In-band management refers to a method where the configuration, monitoring, and control traffic for network devices travels over the same network infrastructure that carries the regular user or production data. Essentially, commands sent to manage a switch or router might use the standard data ports and traverse the same links and intermediate devices as application traffic. This approach can sometimes be perceived as simpler initially, as it may not necessitate setting up a physically distinct network purely for management purposes, potentially leveraging the existing data pathways.

However, relying solely on in-band management can introduce certain challenges and risks. If the primary data network itself encounters problems, such as heavy congestion, a link failure, a device malfunction, or even a significant misconfiguration, the ability to manage the affected devices using the in-band path could also be compromised or completely lost. This dependency might mean that during the very moments when administrative access is most crucial for troubleshooting and remediation, it may become unavailable. Furthermore, sending management traffic alongside production data could potentially raise security considerations, as the management plane might be exposed to threats present on the data network unless stringent security measures like dedicated management VLANs and strict access control lists are carefully implemented. Network performance fluctuations on the data plane might also inadvertently impact the responsiveness of in-band management sessions.

Contrastingly, out-of-band (OOB) management employs a completely separate and dedicated network infrastructure solely for the purpose of accessing and controlling network devices. Network equipment typically features dedicated management ports (often labeled ‘management’, ‘mgmt’, or ‘console’) that can be connected to this parallel management network, which usually consists of its own switches and cabling, physically and logically isolated from the main data-carrying network. The primary advantage of this approach lies in its potential resilience; because the management network is independent, administrators may still be able to access and manage their core infrastructure devices even if the production network experiences a major failure or severe congestion. This separation can provide a reliable lifeline for diagnostics, configuration changes, and system recovery during critical outage events. Additionally, isolating management traffic onto a dedicated network can significantly enhance security posture by drastically reducing the exposure of the management plane to threats potentially originating from or traversing the user data network.

When comparing these two approaches, the choice often involves balancing potential initial simplicity against long-term resilience and security. While in-band management might seem less complex upfront, out-of-band management generally offers a more robust and secure solution, particularly for critical network infrastructure. In the context of AI networks, which often underpin highly valuable and resource-intensive computational workloads running on complex fabric architectures like Leaf-Spine, network stability and rapid troubleshooting capabilities can be paramount. Consequently, implementing a dedicated out-of-band management network might often be considered a best practice or even a necessity. This separate network may ensure that engineers can reliably reach switches, servers, and other vital components to diagnose issues, deploy updates, or make configuration adjustments, regardless of the state of the high-speed data fabric handling the demanding AI traffic patterns. Relying only on in-band access in such environments could introduce unacceptable risks, potentially hindering the ability to resolve problems precisely when swift intervention is most needed.

In the context of network operations and diagnostics, start and stop markers can be understood as logical signals or events that define a specific interval or window for a particular action, observation, or data collection process. These markers are not typically physical entities within a packet itself (though a specially crafted packet could act as such a trigger in some systems) but rather represent commands or state changes within a control system or a set of network devices. A “start marker” event can initiate a process, such as beginning to mark packets for a specific flow, commencing a detailed statistic collection for certain traffic, or applying a temporary policy.

Conversely, a “stop marker” event can signal the termination of that initiated process. For example, it might instruct a device to cease marking packets, conclude the statistic collection for the defined window, or revert a temporary policy. The use of such markers allows for precise control over the scope and duration of network monitoring or diagnostic activities. This is particularly useful for capturing data related to transient events or for limiting the resource impact of intensive monitoring processes by running them only for a necessary period. The period between a start and a stop marker effectively creates a bounded context for data gathering and subsequent analysis.

The generation and propagation of these start and stop signals are often managed by a network controller or a management application. This central entity can coordinate the timing across multiple devices if the observation window needs to be synchronized. For instance, when diagnosing a network issue, an administrator might trigger a start marker, allow the system to collect data for a few seconds or minutes, and then trigger a stop marker. The data collected exclusively within this “start-stop” interval can then be analyzed. This approach helps in isolating relevant information from the continuous stream of network events and data.

In networking, Access Control Lists, commonly known as ACLs, can function as essential filters for managing data flow on network devices such as routers and firewalls. You might think of an ACL like a security guard's checklist at a building entrance; the guard may inspect everyone trying to enter against a set of predetermined rules. Similarly, network devices can use ACLs to examine data packets or their contents that are attempting to traverse the network. Each ACL may consist of a sequence of rules, often called Access Control Entries or ACEs. These rules can specify criteria for evaluating packets, potentially including details like the packet's source and destination IP addresses, the network protocol being used (such as TCP or UDP), and associated port numbers which might indicate the application type (like web or email traffic).

When a packet arrives at a network interface where an ACL may be applied, either for incoming (inbound) or outgoing (outbound) traffic, the device can check the packet against the ACEs in the list sequentially, perhaps starting from the first rule. As soon as the packet's characteristics might match the criteria defined in a rule, the device may execute the corresponding action, which can usually be either to permit the packet to continue its journey or to deny (discard) it. Once a match might be found and the action is taken, the device may stop evaluating further rules in that ACL for that specific packet. It's worth noting that most ACL implementations may include an implicit “deny all” rule at the very end; this can mean if a packet does not match any of the explicitly configured rules, it might be blocked by default. The primary purposes for employing ACLs can include enhancing network security, potentially by blocking unauthorized or malicious traffic, and controlling traffic flow, possibly by dictating which network segments or users may be allowed to communicate with specific resources.

Building upon this foundation, the concept of a “counting ACL” can emerge not as a different kind of list, but possibly as an added capability to standard ACL functionality. This feature can allow network administrators to gather statistics on how often specific rules within an ACL might be matched. When configuring an ACE, it may be possible to enable a counting mechanism for that particular rule. Subsequently, every time a data packet meets the criteria of that specific ACE, the network device can increment a dedicated counter associated with that rule, in addition to potentially performing the prescribed permit or deny action.

For instance, consider a scenario where you may need to track packets marked with a specific indicator in their header, perhaps for Quality of Service (QoS) verification. Network traffic might be marked using a DSCP (Differentiated Services Code Point) value, like ‘EF’ for Expedited Forwarding, possibly used for voice traffic. An administrator might configure an ACE within an ACL designed to match any packet carrying the ‘EF’ DSCP marker. This rule may likely be set to permit the traffic, potentially ensuring the priority packets proceed, but it might also be configured to count each match. This may mean the associated counter can increase every time such a packet passes through, potentially providing a direct measure of that specific traffic type.

The utility of counting ACLs may lie in the visibility they can provide. These counters can be invaluable for monitoring network traffic patterns, allowing administrators to see potentially how much traffic aligns with certain rules. They can greatly assist in troubleshooting connectivity or policy issues, as checking the hit counts may reveal whether packets are being processed by the intended rule or perhaps being unexpectedly blocked or permitted elsewhere. Furthermore, counting ACLs can be crucial for verifying QoS policies, like in the DSCP example, helping ensure that traffic prioritization may be functioning as expected and quantifying the volume. From a security perspective, monitoring the counters on deny rules might help identify potential reconnaissance or attack attempts if certain deny rules show rapidly increasing hit counts. This statistical data may also aid in capacity planning by potentially offering insights into the volume of specific types of application traffic traversing the network. In essence, while standard ACLs can control network access, counting ACLs may add a vital layer of quantifiable insight into network operations.

In various embodiments, the overall process for identifying potential packet loss within a network fabric can begin with a determination of a suitable packet marking methodology, which may involve selecting specific fields or bits within packet headers that can be altered and subsequently identified by network devices. Following this, in some embodiments, network devices along potential paths of a flow of interest can be primed or configured, perhaps using Access Control Lists (ACLs) or limited Netflow tables, to recognize and count packets bearing these specific markings on their incoming and outgoing interfaces. In further embodiments, a designated ingress switch can then be triggered to commence applying these marks to packets of a particular flow for a defined duration, and subsequently triggered to cease such marking, thereby creating a bounded window of observation. After a suitable propagation time, the accumulated count statistics for these marked packets can be collected from the various network devices. It is at this juncture that the correlation and analysis phase may be initiated; this phase can utilize the collected packet counts from across the network, comparing them against expected values and the principle of packet conservation at each node (where incoming marked packets ideally equal outgoing marked packets) to systematically identify discrepancies and thereby pinpoint one or more nodes or links that may be responsible for packet drops within the fabric.

In many embodiments, the correlation and analysis phase can commence after a designated period for statistic collection may have concluded and when relevant count data can be exported from participating network nodes. This gathered information, which may consist of the number of marked packets observed on various incoming and outgoing interfaces for a specific flow under investigation, can form a basis for a diagnostic process. In some embodiments, a central entity, such as a network controller, packet debugging logic, or a dedicated analysis tool, may aggregate this distributed dataset. This logic can then systematically organize the counts, potentially associating them with specific nodes and interfaces within the fabric topology to help build a comprehensive picture of how the marked flow may have traversed the network during an observation window.

In a number of embodiments a given flow, for instance, a flow from a source S to a destination D, which may be denoted as F_{sd}, the total number of marked packets that can enter a node through all its incoming interfaces could ideally equal the total number of marked packets that may exit that same node through all its outgoing interfaces, assuming no internal drops were to occur within that node. This relationship, in various embodiments, can be expressed such that a summation of packets for flow F_{sd} on all incoming interfaces (denoted as IIF) may be equal to a summation of packets for that flow on all outgoing interfaces, which can serve as an ideal state or baseline against which collected statistics for each node may be compared.

ΣIIF·F_{sd}=ΣOIF·F_{sd}

In additional embodiments, when an analysis reveals a potential deviation from this baseline at a particular network node, it may serve as a strong indicator of packet loss possibly occurring within that specific node. For example, if a total count of marked packets for flow F_{sd} arriving at a switch via its various input ports appears greater than a total count of the same marked packets leaving that switch through its output ports, such a discrepancy can point toward packets potentially being dropped by that switch. The magnitude of this difference, in certain embodiments, may quantify the number of packets that could have been lost by that node during the timed observation. This localized check, which may be repeated for every node involved in the paths of flow F_{sd}, can allow for the systematic identification of individual hardware elements that might be misbehaving.

Beyond individual node analysis, in still more embodiments, the correlation process can be extended to comparing packet counts along the entirety of potential paths that flow F_{sd} may have taken. By potentially tracing an expected number of packets from a source leaf switch outwards, and comparing these counts at each subsequent hop, which may include spine switches, super-spine switches, and eventually a destination leaf switch, a pattern of packet progression or attrition can emerge. If, in an embodiment, a first hop switch reports K marked packets egressing towards the fabric, but a sum of marked packets received by all directly connected spine switches is determined to be less than K, then a loss may be isolated to links or interfaces between that leaf and those spine switches. This comparative analysis, which may be applied systematically from one tier of the fabric to the next in various embodiments, can effectively help narrow down the location of a drop, even in complex scenarios where traffic might be sprayed across numerous parallel paths, thereby assisting in pinpointing a precise segment or set of nodes that could be responsible for packet loss experienced by an application.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

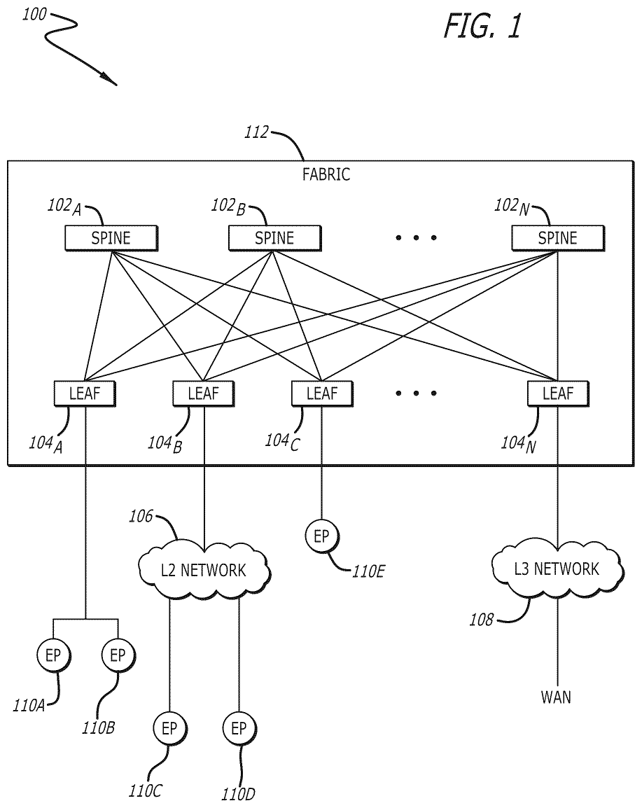

Referring to FIG. 1, a schematic block diagram of an example architecture 100 for a network fabric 112, in accordance with various embodiments, is shown. The network fabric 112 can include spine switches 102A, 102B, . . . , 102N (collectively referenced as spine switches 102) connected to leaf switches 104A, 104B, 104C, . . . , 104N (collectively referenced as leaf switches 104) within the network fabric 112. As commonly understood, a networking fabric can refer to an interconnect system, often characterized by high speed and high bandwidth, that enables multiple devices to communicate efficiently and reliably. It may represent a network topology designed to provide a flexible and scalable infrastructure for environments such as data centers or cloud platforms. Various embodiments described herein can include a leaf-spine architecture comprising a plurality of spine switches and leaf switches.

In many embodiments, spine switches 102 can function primarily as Layer 3 (L3) switches within the fabric 112. However, in some embodiments, the spine switches 102 can also, or alternatively, perform Layer 2 (L2) functionalities. Further, the spine switches 102 can be configured to support various capabilities and high-speed Ethernet connections. In some embodiments, the spine switches 102 can be configured with ports supporting various speeds, such as 10, 40, 100, or 400 Gigabit Ethernet. In certain embodiments, ports operating at a higher speed can also be configured to support multiple connections at lower speeds. For example, a 400 Gigabit Ethernet port might be split into multiple 100 Gigabit Ethernet ports, although a variety of other configurations may be possible. In the context of network monitoring as described herein, these spine switches 102 may represent some of the plurality of network nodes where packet counting could occur.

In various embodiments, one or more spine switches 102 can connect to one or more leaf switches 104 within the fabric 112. Leaf switches 104 can include access ports (or non-fabric ports) and fabric ports. Fabric ports can provide uplinks connecting the leaf switches 104 to the spine switches 102, while access ports can provide connectivity for devices, hosts, endpoints, virtual machines (VMs), or external networks to the fabric 112. In many embodiments, leaf switches 104 can reside at the edge of the fabric 112 and can thus represent the physical network edge where data flows may originate or terminate. In some embodiments, the leaf switches 104 can be top-of-rack (“ToR”) switches. In certain embodiments, the leaf switches 104 can be aggregation switches in other topologies, such as end-of-row (EoR) or middle-of-row (MoR).

In additional embodiments, the leaf switches 104 can be responsible for routing and/or bridging various packets and potentially applying network policies. In some embodiments, a leaf switch 104 can perform one or more additional functions relevant to network monitoring and diagnostics, such as implementing packet marking at an ingress point, counting marked packets arriving at ingress ports or departing from egress ports based on configured ACLs or other mechanisms, and exporting count data to a monitoring entity like packet debugging logic. Moreover, in certain embodiments, leaf switches 104 can contain virtual switching functionalities or act as gateways between the fabric 112 and overlay networks.

In further embodiments, network connectivity in the fabric 112 can flow through the leaf switches 104. Here, the leaf switches 104 can provide servers, resources, endpoints (EP) 110A-E (collectively referenced as endpoints 110), external networks, or VMs access to the fabric 112, and can connect the leaf switches 104 to each other via the spine switches 102. In some embodiments, the leaf switches 104 can connect specific endpoint groups to the fabric 112 and/or to external networks. Each endpoint or endpoint group may connect to the fabric 112 via one or more of the leaf switches 104. For example, endpoints 110A and 110B can connect directly to leaf switch 104A. Similarly, endpoint 110E can connect directly to leaf switch 104C. In certain embodiments, connectivity may be indirect; for instance, endpoints 110C and 110D can connect to leaf switch 104B via an intermediate L2 network 106. Likewise, external networks, such as a wide area network (WAN), might connect to leaf switches (like 104N, although connection is shown to L3 network 108 first) via an L3 network 108.

In certain embodiments, endpoints 110 can include any communication device, such as a computer, a server (potentially hosting VMs or containers), a storage device, a switch, a router, or other network elements. These endpoints 110 can be the sources or destinations of data flows that might be monitored for packet loss using techniques described herein. For example, endpoint 110A could be a source sending traffic to endpoint 110E, traversing leaf switch 104A, one or more spine switches 102, and leaf switch 104C. Each of these switches (104A, 104B, 104C) could be configured to count marked packets associated with this flow to help identify potential mismatches or loss along the path within fabric 112.

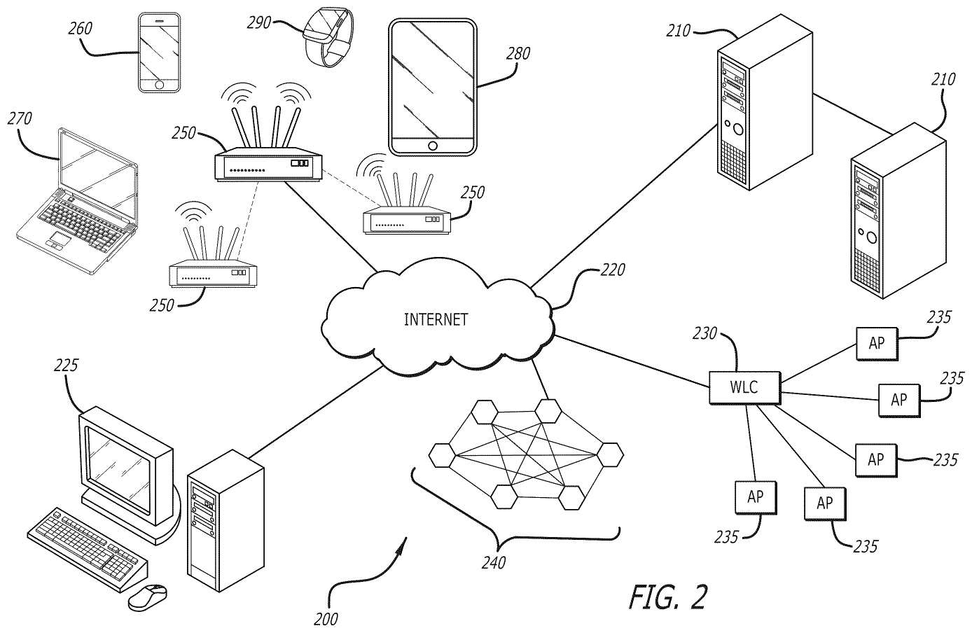

Although a specific embodiment for an architecture 100 is described above with respect to FIG. 1, any of a variety of systems and/or processes may be utilized in accordance with various embodiments. For example, the endpoints 110A-E could represent GPU systems involved in AI training workloads, and the fabric 112 could be monitored by packet debugging logic to ensure reliable communication. The elements depicted in FIG. 1 may also be interchangeable with other elements or represent components within larger systems, such as those illustrated in FIG. 2-9, as required to realize a particularly desired embodiment.

Referring to FIG. 2, a conceptual network diagram 200 of various environments that a packet debugging logic may operate, in accordance with various embodiments of the disclosure is shown. This diagram 200 depicts a plurality of computing devices and network infrastructure components that can be interconnected, representing potential environments where network monitoring and diagnostic functionalities, such as those provided by packet debugging logic, may be deployed or utilized.

In many embodiments, the diagram 200 includes components often found in enterprise or data center environments, such as one or more servers 210 and potentially a deployed network 240. The servers 210 could host applications, services, or network management tools. In some embodiments, a server 210 or a desktop computer 225 could host or interact with packet debugging logic used to monitor network segments. The deployed network 240, depicted abstractly, could represent a complex network fabric, perhaps employing spine-leaf architectures, where monitoring for packet loss within specific segments might be performed according to methods described herein. These components can be interconnected via a wider network 220, such as the Internet.

In various embodiments, the diagram 200 also illustrates access network components. These can include devices like wireless access points (APs) or home routers 250 that provide network connectivity to various end-user devices. Additionally, a wireless LAN controller (WLC) 230 managing multiple APs 235 is shown, representing a centrally managed wireless network infrastructure that might exist alongside or connect to wired network segments. These access network components facilitate communication between end-user devices and other network resources, such as servers 210 or services within the deployed network 240, potentially traversing the network 220. Monitoring traffic within these access segments could also be relevant in certain diagnostic scenarios.

In certain embodiments, a variety of end-user devices are shown connecting through the access network components. These can include devices such as a cellular phone 260, a laptop computer 270, a portable tablet or smartphone 280, and a wearable computing device 290. These devices can act as sources or destinations for data flows within the overall network environment. In some embodiments, identifying performance issues or packet loss affecting these specific devices or the applications they run might involve initiating monitoring procedures on relevant segments of the network infrastructure they connect through, potentially orchestrated by packet debugging logic.

In some embodiments, the environment depicted in FIG. 2 illustrates the heterogeneity of networks where monitoring and diagnostics may be needed. The packet debugging logic and associated methods could be applied selectively to different parts of this environment. For instance, detailed packet marking and counting methods might be primarily applied within a high-performance deployed network fabric represented by network 240, while monitoring related to devices connecting via home routers 250 or APs 235 might involve different techniques or levels of granularity. A controlling entity, perhaps located on a server 210 or operating as a cloud service accessible via network 220, could manage diagnostic sessions across these diverse network segments.

Although a specific embodiment for various network environments and devices is discussed with respect to FIG. 2, any of a variety of systems and device arrangements may be utilized in accordance with various embodiments. For example, packet debugging logic described herein could be hosted on one of the servers 210 and used to monitor traffic flows originating from a cellular phone 260 passing through network 220 to reach services within the deployed network 240. The elements depicted may also be interchangeable with other elements or represent components within systems as required to realize a particularly desired embodiment.

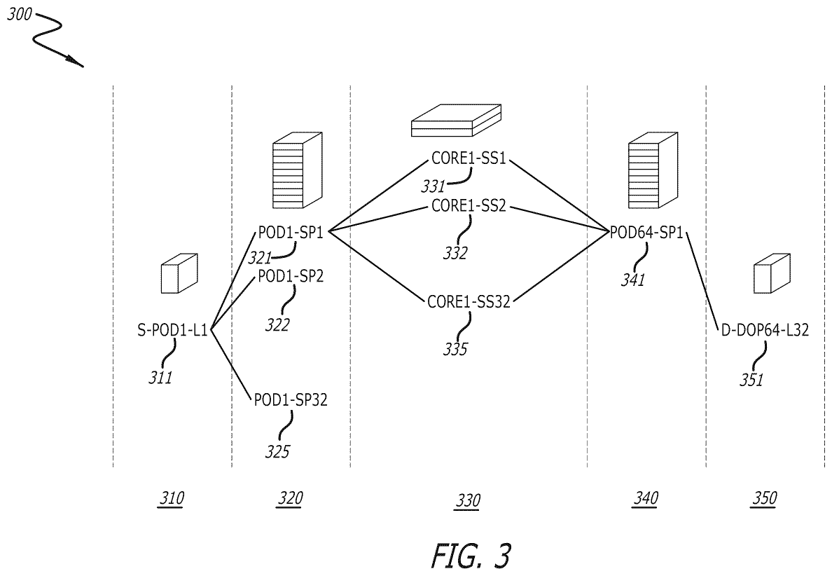

Referring to FIG. 3, a schematic diagram of an exemplary network path 300 through a multi-stage fabric, in accordance with various embodiments is shown. This network path 300 can illustrate the traversal of data through various layers or stages of a complex network, such as those that may be found in large-scale data centers or AI computing clusters, comprising Leaf, Spine, and Superspine switch layers. The path is depicted across several vertical sections, which may represent distinct logical or physical groupings of network equipment, including a source Leaf switch section 310, a source pod Spine switch section 320, a core Superspine switch section 330, a destination pod Spine switch section 340, and a destination Leaf switch section 350.

In many embodiments, the network path may originate from a source endpoint, designated as S-POD1-L1 source 311, which can be located in the source Leaf switch section 310. This source 311 may represent a host system connected to a Leaf switch (L1) within a first pod (e.g., POD1). From this ingress Leaf switch, data packets can be forwarded to one of several Spine switches (SP) within the same pod, illustrated in the source pod Spine switch section 320. For instance, connections are shown from the source endpoint S-POD1-L1 source 311 (implying its connection via Leaf switch L1) to multiple Spine switches such as POD1-SP1 321, POD1-SP2 322, and POD1-SP32 325. This indicates that multiple paths may be available from a Leaf switch to the Spine switch layer of its pod, which can facilitate load balancing or traffic spraying.

In a number of embodiments, from a Spine switch in the source pod, such as POD1-SP2 322, data can then traverse to a higher-tier core layer composed of Superspine switches (SS), represented by the core Superspine switch section 330. This core layer may comprise multiple Superspine switches, for example, CORE1-SS1 331, CORE1-SS2 332, and CORE1-SS32 335. A connection is shown from the Spine switch POD1-SP2 322 to the Superspine switch CORE1-SS2 332, illustrating a path into this core layer. It is contemplated that a packet could be routed through any of the available Superspine switches in this core layer, providing further opportunities for multipath routing and resilience within the fabric. The number of such core Superspine switches can vary based on the overall desired bandwidth and fault tolerance of the network.

In more embodiments, after traversing the core Superspine switch section 330, data destined for an endpoint in a different pod can be routed towards the Spine switch layer of the destination pod, represented by the destination pod Spine switch section 340. As an example, a connection is shown from the core Superspine switch CORE1-SS2 332 to a Spine switch in the destination pod, POD64-SP1 switch 341. From this destination pod Spine switch 341, the data can then be forwarded to a Leaf switch in the destination pod, within the destination Leaf switch section 350, to which the final destination endpoint, such as D-DOP64-L32 destination 351 (representing a destination connected to Leaf switch L32 in, for example, POD64), is connected. This destination 351 could represent another host system.

In further embodiments, the arrangement shown in the network path 300 can exemplify a typical path through a multi-stage CLOS network topology (e.g., a 5-stage fabric involving Leaf-Spine-Superspine-Spine-Leaf traversal from source to destination endpoint). This type of architecture is commonly used in high-performance network fabrics to provide high bisection bandwidth and low latency. The depiction of multiple switches at the Spine layers (e.g., POD1-SP1 321, POD1-SP32 325) and Superspine layer (e.g., CORE1-SS1 331, CORE1-SS32 335), even if not all are part of the single highlighted path from source 311 to destination 351, can serve to illustrate the richness of connectivity and the potential for numerous parallel paths between any two endpoints in such a fabric. Understanding such paths, involving transitions from a source Leaf switch, to a source-side Spine switch, to a Superspine switch, then to a destination-side Spine switch, and finally to a destination Leaf switch, can be crucial when diagnosing network performance issues or attempting to trace packet loss.

Although a specific embodiment for an exemplary network path through a multi-stage fabric is discussed with respect to FIG. 3, any of a variety of network architectures and component arrangements may be represented or utilized in accordance with various embodiments. For example, the number of Spine switches per POD, the quantity of Superspine switches in the core layer, or the number of core layers themselves, can vary significantly depending on the scale, desired oversubscription ratios, and radix of the switches used in a particular deployment. The elements and connections depicted in FIG. 3 may also be representative of logical paths in a virtualized network environment, and aspects of this diagram may be relevant to understanding packet flow in other figures, such as FIG. 1-2 and FIG. 4-9, as required to realize a particularly desired embodiment.

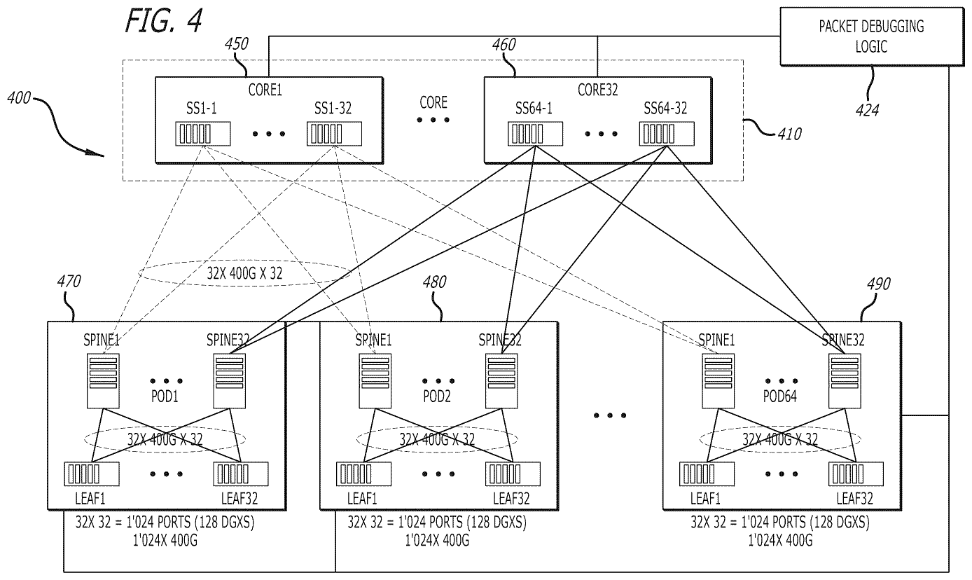

Referring to FIG. 4, a schematic diagram of a large-scale network fabric architecture 400, which may incorporate packet debugging logic, in accordance with various embodiments is shown. In many embodiments, each POD, such as POD1 470, POD2 480, or POD64 490, can function as a modular building block of the large-scale network fabric architecture 400. A POD may include a set of Leaf switches (labeled LEAF1 through LEAF32 within each POD) and a set of Spine switches (labeled SPINE1 through SPINE32 within each POD). For instance, within POD1 470, Leaf switches may connect to host devices such as servers or GPU systems, providing an aggregated host-facing capacity indicated by notations like “32×32=1,024 PORTS (128 DGXS)” and “1,024×400G,” which can signify 1024 ports of 400 Gbps capacity per POD for end-node connectivity. These Leaf switches can then connect upwards to the Spine switches within the same POD, with interconnectivity that might be represented by “32×400G×32,” indicating numerous high-speed links between the Leaf and Spine layers of a POD.

In a number of embodiments, the core layer 410 of the large-scale network fabric architecture 400 can consist of multiple core units or chassis, such as CORE1 450 and CORE32 460, with ellipses indicating the potential for additional core units. Each of these core units may house a number of Superspine (SS) switches. For example, CORE1 450 is shown to contain Superspine switches SS1-1 through SS1-32, and CORE32 460 is shown with Superspine switches SS64-1 through SS64-32. This nomenclature can suggest a very large number of Superspine switches distributed across the core units, forming a powerful central switching stage for the large-scale network fabric architecture 400. It is contemplated that these Superspine switches provide high-bandwidth pathways between the different PODs.

In more embodiments, connectivity within the large-scale network fabric architecture 400 involves links from the Spine switches in each POD to the Superspine switches in the core layer 410. As illustrated, Spine switches from POD1 470 and POD64 490 can connect to Superspine switches within both CORE1 450 and CORE32 460. This meshed or partially-meshed interconnection between the POD Spine switches and the Core Superspine switches can create a highly resilient and scalable network, allowing for extensive multipathing and load distribution for traffic traversing between different PODs. The diagram depicts these connections as ellipses containing “32×400G×32” between the PODs' Spine layer and the Core layer, which may represent the aggregated connectivity or bandwidth characteristics of these inter-stage links.

In further embodiments, the packet debugging logic 424 can be a component utilized for aiding in the maintenance of health and performance of such a complex large-scale network fabric architecture 400. Its connection to the layer 410 may signify an ability to interact with, and potentially receive data from or send control instructions to, individual devices throughout the Leaf, Spine, and Core layers. This interaction can enable detailed counting and analysis operations for the purpose of diagnosing network issues. For example, if a specific data flow from a source connected to a Leaf switch in POD1 470 to a destination connected to a Leaf switch in POD64 490 is suspected of experiencing packet loss, the packet debugging logic 424 could orchestrate a diagnostic sequence. It might instruct the source-side Leaf switch to begin marking packets for this flow and to count these marked packets as they egress.

Concurrently, the packet debugging logic 424 may also instruct intermediate Spine switches within POD1 470, relevant Superspine switches within the core layer 410 (e.g., in CORE1 450 or CORE32 460), and subsequent Spine and Leaf switches in POD64 490 along potential paths of the flow to count these same marked packets on their respective ingress and egress interfaces. By collecting and comparing these distributed counts, the packet debugging logic 424 can then perform an analysis; for instance, if a Spine switch in POD1 reports a certain number of marked packets exiting towards the core, and a connected Superspine switch reports a lower number of the same marked packets arriving, the logic 424 can help pinpoint the loss to the link segment between these two devices or to the ingress stage of the Superspine switch.

Although a specific embodiment for a large-scale network fabric architecture with packet debugging logic is discussed with respect to FIG. 4, any of a variety of network designs and capacities may be realized in accordance with various embodiments. For example, the number of core units, or the specific arrangement and quantity of Superspine switches within each core unit, or the number of PODs and their internal Leaf-Spine configurations, can be adapted based on the total required switching capacity and desired fault tolerance domains, and the specific needs of the workloads the fabric is intended to support. The elements and connections depicted in FIG. 4 may also be relevant to understanding the operational context of processes illustrated in FIG. 1-3 and FIGS. 5-9, as required to realize a particularly desired embodiment.

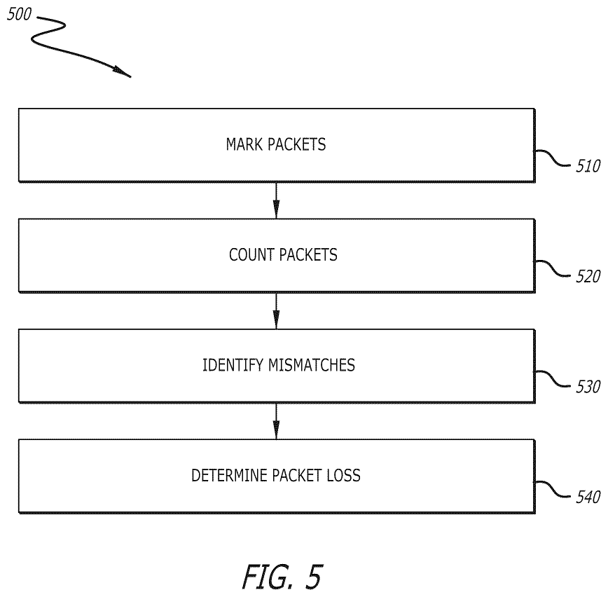

Referring to FIG. 5, a flowchart showing a high-level process 500 for identifying potential packet loss, in accordance with various embodiments is shown. In many embodiments, the process 500 can mark packets (block 510). This operation may involve altering one or more bits or fields in the headers of packets belonging to a specific flow, which can allow these packets to be uniquely identified. In some embodiments, the marking can be achieved by setting specific reserved bits within Layer 3 or Layer 4 packet headers, such as a designated bit in an IP header or a transport layer header. In certain embodiments, for certain types of traffic, the marking could be applied to an outer encapsulation header, for example, using reserved fields within a VxLAN header, which can allow for identification even when inner packet details are not inspected by intermediate fabric nodes.

In a number of embodiments, the process 500 can count packets (block 520). Operations for counting packets may involve network devices being configured to count packets that possess certain markings as they are observed. In some embodiments, this packet counting can be implemented by configuring Access Control Lists (ACLs) on the network devices, where ACL entries are designed to match specific packet characteristics, such as defined markings, and trigger a counter increment. In various embodiments, network devices might employ a targeted, lightweight flow-monitoring mechanism, distinct from full NetFlow, that is specifically instantiated to count only those packets bearing particular debug markings for a flow of interest, thereby potentially minimizing resource consumption on the device.

In more embodiments, the process 500 can identify mismatches (block 530). This operation may involve analyzing available packet count data to find discrepancies where the number of observed packets changes unexpectedly between different observation points or accounting interfaces. In some embodiments, this identification can be approached by a central network management system or a dedicated analysis application reviewing collected distributed count data and systematically comparing the number of packets with specific markings reported as entering a network node against the number reported as exiting that same node. In certain embodiments, mismatches might be identified in a more distributed fashion, where each network node, or a subset of nodes, can be configured to locally compare its own ingress and egress counts for a flow exhibiting defined markings and flag any detected discrepancies directly to a management entity or logging system.

In further embodiments, the process 500 can determine packet loss (block 540). A determination regarding the location and potential magnitude of packet loss can be made when, for instance, identified discrepancies in packet counts suggest such an occurrence. In some embodiments, if a specific network node consistently shows fewer packets with certain markings egressing than ingressing for a monitored flow, that node can be identified as a potential point of loss. In various embodiments, the determination of packet loss may involve not just a single node, but correlating count data between different nodes; a significant drop in packet counts (for packets with particular characteristics) between the egress of an upstream node and the ingress of a directly connected downstream node could indicate loss on the interconnecting link or at the ingress stage of the downstream node.

Although a specific embodiment for a high-level process 500 for identifying potential packet loss is discussed with respect to FIG. 5, any of a variety of systems and/or devices may be utilized to carry out the operations in accordance with various embodiments. For example, the process 500 may be orchestrated and its operations performed or initiated by a central network controller, or by distributed packet debugging logic integrated within the network fabric. The elements and operations depicted may also be part of more detailed processes or combined with operations from other processes as required to realize a particularly desired embodiment.

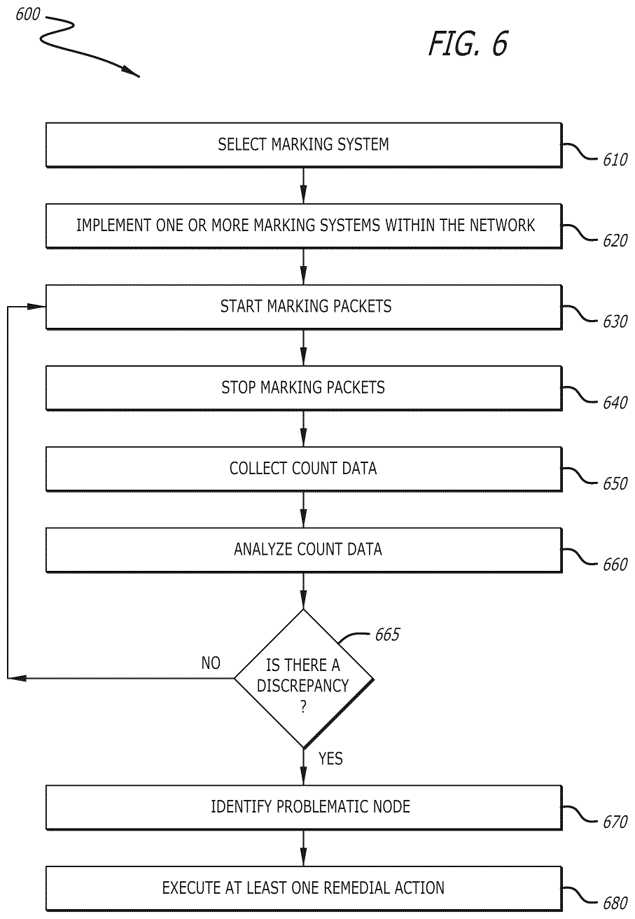

Referring to FIG. 6, a flowchart illustrating a process 600 for network analysis and remediation, in accordance with various embodiments is shown. In many embodiments, the process 600 can select marking system (block 610). This selection of a marking system may involve choosing a specific method for altering packet headers to uniquely identify packets belonging to a flow of interest. In some embodiments, the selection could be based on the types of network devices in the fabric and their capabilities to recognize certain header manipulations, such as setting reserved bits in an IP header. In certain embodiments, the system selection might also consider the type of traffic being analyzed, such as choosing a marking scheme compatible with encapsulated or tunneled packets.

In a number of embodiments, the process 600 can implement one or more marking systems within the network (block 620). This implementation may entail configuring network devices to recognize and act upon the selected marking system or systems. In some embodiments, this could involve distributing policies to relevant switches that define the specific header fields and bit patterns constituting a “marked” packet for counting purposes. In various embodiments, this could involve activating specific firmware capabilities on network devices designed to handle the chosen marking protocols.

In more embodiments, the process 600 can start marking packets (block 630). This operation can involve an ingress network device beginning to apply the chosen marks to packets of a designated flow for a defined period. In various embodiments, this defined period is at least a predetermined period of time or other temporal values. In some embodiments, a network controller might send a command to a specific leaf switch to initiate the marking of all packets originating from a particular source and destined for a particular recipient. In certain embodiments, the start of packet marking could be triggered by certain network conditions, values, or performance thresholds being met, rather than a direct command.

In further embodiments, the process 600 can stop marking packets (block 640). This operation typically involves the ingress network device ceasing to apply the marks to new packets of the designated flow. In some embodiments, this cessation could be triggered by a timer expiring, a specific command from a controller, or after a predetermined number of packets have been marked. In various embodiments, the stopping of marking might occur dynamically if the system determines sufficient data has been gathered or if network conditions change.

In additional embodiments, the process 600 can collect count data (block 650). This collection may involve gathering statistics from various network devices regarding the number of marked packets observed on their respective ingress and egress interfaces. In some embodiments, a central management system could poll each relevant switch to retrieve the counters associated with the marked packets. In certain embodiments, network devices could be configured to autonomously push their count data for marked packets to a designated collection server once the marking period has concluded.

In still more embodiments, the process 600 can analyze count data (block 660). This analysis can involve processing the collected count data to compare the number of marked packets at different points in the network. In some embodiments, software tools might be used to compare the count of marked packets leaving one device with the count arriving at the next hop device along a path. In various embodiments, this analysis could involve comparing ingress and egress counts for marked packets within a single device to check for internal drops.

In yet further embodiments, the process 600 can determine if there is a discrepancy (block 665). If, based on the analysis of count data, no discrepancy is found (e.g., packet counts are consistent across the monitored path), then the process 600 can once again start marking packets (block 630), potentially for a different flow or a subsequent observation window. However, if a discrepancy is found (e.g., a drop in marked packet counts is detected), then the process 600 can identify problematic node (block 670). Following a determination that a discrepancy exists, operations to identify a problematic node may commence. In some embodiments, the identification can involve pinpointing the specific network device or link where the count of marked packets decreases significantly, suggesting that the node or link is the source of packet loss. In certain embodiments, this identification may use data from multiple observation periods or correlate with other network events to improve accuracy, such as looking for corresponding error counters on switch interfaces. In various embodiments, techniques such as progressively narrowing the scope of monitoring can be used to isolate the problematic element.

In numerous embodiments, the process 600 can execute or otherwise elicit at least one remedial action (block 680). Once a problematic node or link has been identified, one or more actions may be taken to address the issue. In some embodiments, a remedial action could involve re-routing traffic away from the identified faulty component. In certain embodiments, the remedial action might involve automatically generating an alert for a network administrator, providing details about the identified problem and the affected flow, or attempting to reset or reconfigure the problematic network device or interface.

Although a specific embodiment for a process for network analysis and remediation is discussed with respect to FIG. 6, any of a variety of systems and/or devices may be utilized to carry out the operations in accordance with various embodiments. In some embodiments, the process 600 may be implemented on a dedicated network monitoring appliance, or its functionalities could be integrated into the management plane software of network switches or a centralized network controller. The elements and operations depicted in FIG. 6 may also be interchangeable with other elements or operations of FIG. 1-5 and FIG. 7-9 as required to realize a particularly desired embodiment.

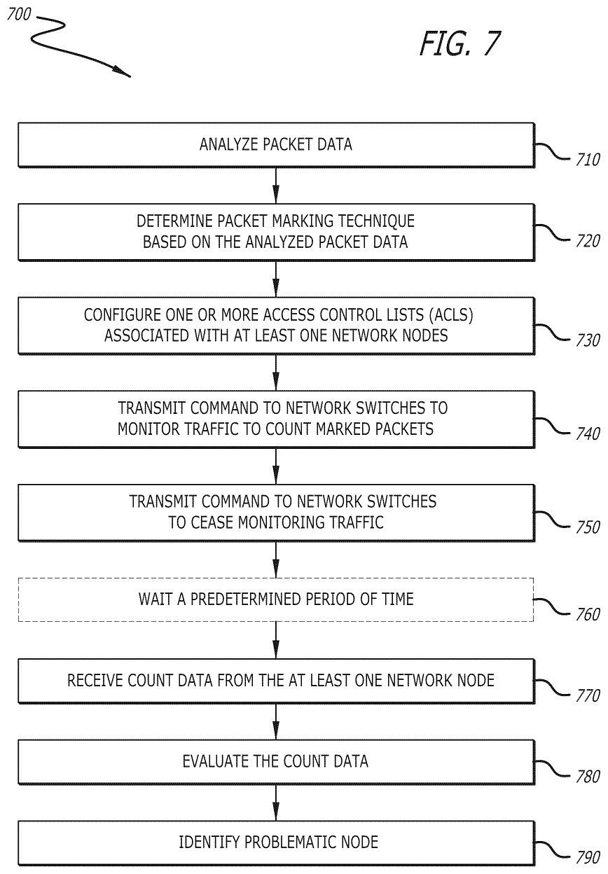

Referring to FIG. 7, a flowchart depicting a process 700 for generating a charging instruction signal, in accordance with various embodiments of the disclosure is shown. In many embodiments, the process 700 can analyze packet data (block 710). This analysis may involve examining characteristics of typical network traffic or specific flows within a segment of the data network selected for monitoring. In some embodiments, the analysis could focus on packet header formats and field usage across different protocols transiting the network segment to identify potential fields suitable for packet marking. In certain embodiments, this analysis might be performed by a packet debugging logic component based on captured sample traffic or predefined network profiles.

In a number of embodiments, the process 700 can determine packet marking technique based on the analyzed packet data (block 720). A specific technique for marking packets belonging to a data flow targeted for monitoring can be selected. In some embodiments, the determination might result in choosing to set reserved bits within an IP header or a transport-layer header (like RoCEv2) based on the findings of the packet data analysis. In various embodiments, if the analysis indicates the presence of encapsulated traffic, a technique involving marking an outer header, such as a VxLAN header, might be determined to be more appropriate.

In more embodiments, the process 700 can configure one or more access control lists (ACLs) associated with at least one network nodes (block 730). This operation may involve preparing network devices within the monitored segment to recognize and count packets according to the determined marking technique. In some embodiments, a controlling entity could transmit configuration commands to program ACL entries on relevant network nodes (switches, routers) to match the specific marked packet pattern and associate a counting action with that match. In certain embodiments, instead of or in addition to ACLs, configurations for other hardware-based counting mechanisms, such as targeted flow monitoring tables, could be implemented on the network nodes.

In further embodiments, the process 700 can transmit command to network switches to monitor traffic to count marked packets (block 740). A command can be sent to initiate the monitoring and counting process on designated network switches or nodes within the segment. In some embodiments, this command could be sent from an external device or packet debugging logic via a secure management channel. In various embodiments, this command may also implicitly or explicitly define the start of an observation period and could include an indication of the type of marked packet to count or the specific data flow being monitored.

In additional embodiments, the process 700 can transmit command to network switches to cease monitoring traffic (block 750). A subsequent command can be sent to instruct the network switches to stop actively monitoring and counting the marked packets. In some embodiments, this command might be transmitted after a predetermined period has elapsed since the start command, or upon manual intervention. In certain embodiments, this command could trigger the network devices not only to stop counting but also to prepare their collected count data for transmission.

In still more embodiments, the process 700 can wait a predetermined period of time (block 760). A waiting period may optionally be observed, potentially after the command to cease monitoring has been sent. In some embodiments, this wait time could be configured to allow sufficient time for the last marked packets of the observation window to propagate through the monitored network segment and be counted by downstream nodes. In various embodiments, the duration of this period could be fixed, configurable, or dynamically calculated based on estimated network latency.

In yet further embodiments, the process 700 can receive count data from the at least one network node (block 770). Count data, generated by the network nodes based on their observation of marked packets, can be collected by a central entity, such as the packet debugging logic. In some embodiments, the network nodes might push this data automatically after ceasing monitoring. In certain embodiments, the controlling entity might pull the data by sending specific requests. This received count data may comprise values associated with marked packets arriving at ingress points and departing from egress points of the network nodes.

In numerous embodiments, the process 700 can evaluate the count data (block 780). The received count data can be processed and analyzed to identify potential issues. In some embodiments, this evaluation can involve comparing ingress marked packet counts against egress marked packet counts for individual network nodes to check for discrepancies. In various embodiments, the evaluation might also correlate counts across adjacent nodes or along potential data flow paths to understand packet progression through the monitored segment.

In some embodiments, the process 700 can identify problematic node (block 790). Based on the evaluation of the count data, one or more network nodes (or potentially links) exhibiting behavior indicative of packet loss, such as significant mismatches between ingress and egress counts, can be identified. In some embodiments, the identity of a node where egress counts are consistently lower than ingress counts for the marked flow could be logged. This identification may then be used, in certain embodiments, to generate notifications or trigger remedial actions.

Although a specific embodiment for a process for managing network monitoring and diagnostics is discussed with respect to FIG. 7, any of a variety of systems and/or devices may be utilized to carry out the operations in accordance with various embodiments. For example, the packet debugging logic performing aspects of process 700 could be implemented as a standalone server application or as a distributed function across network management infrastructure coordinating with multiple network devices. The elements and operations depicted in FIG. 7 may also be part of more detailed processes or combined with operations from other processes, such as those that may be illustrated in FIG. 1-6 and FIG. 8-9, as required to realize a particularly desired embodiment.

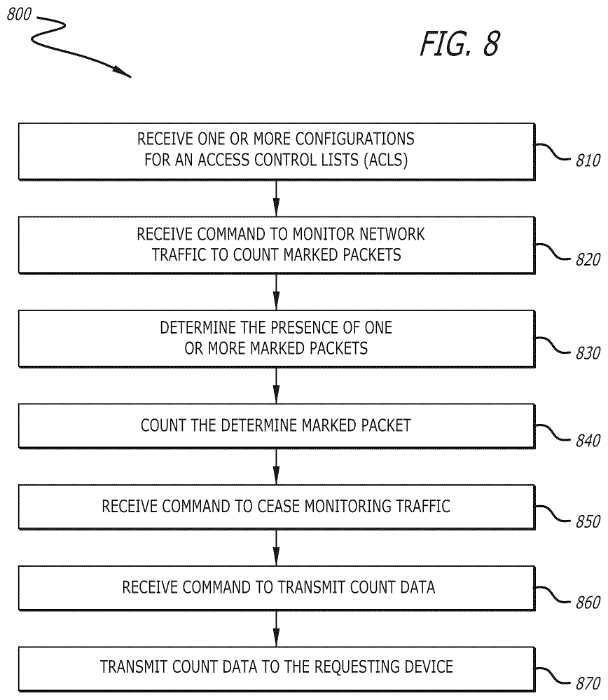

Referring to FIG. 8, a flowchart illustrating a process 800 for packet monitoring and data reporting is shown. In many embodiments, the process 800 can receive one or more configurations for an access control lists (ACLs) (block 810). Such configurations may define rules that the network device can use to identify specific types of network traffic. In some embodiments, these ACL configurations might be pushed to the network device from a centralized network controller or management station. In certain embodiments, the configurations could specify complex matching criteria, including combinations of source and destination addresses, port numbers, protocol types, or even user-defined fields (UDFs) within packet headers.

In a number of embodiments, the process 800 can receive command to monitor network traffic to count marked packets (block 820). This command may act as a trigger for the network device to begin actively looking for and counting packets that possess specific characteristics defined as “marked.” In some embodiments, the command could be received via a secure management interface using a standard network management protocol or a proprietary API call. In various embodiments, the command might specify a particular duration for the monitoring period, or it could instruct the device to monitor indefinitely until a subsequent command to cease is received.

In more embodiments, the process 800 can determine the presence of one or more marked packets (block 830). This operation may involve the network device inspecting passing packets and comparing their header information against the previously received ACL configurations to identify those that match the marking criteria. In some embodiments, the determination could rely on identifying a specific bit pattern set in a reserved field of an IP header, a RoCEv2 header, or a VxLAN encapsulation header. In certain embodiments, this determination can be performed by a hardware packet processing pipeline within the network device to ensure line-rate performance.

In further embodiments, the process 800 can count the determine marked packet (block 840). Once a packet is determined to be marked, an operation to count it can occur. In some embodiments, this counting may involve incrementing one or more hardware-based counters specifically associated with the ACL rule that matched the marked packet. In various embodiments, separate counts could be maintained for marked packets on a per-interface basis, or even on a more granular per-flow basis if the ACL configurations and device capabilities support such detail.

In additional embodiments, the process 800 can receive command to cease monitoring traffic (block 850). This command can signal the network device to stop the active process of identifying and counting marked packets. In some embodiments, this command might originate from the same management entity that issued the initial command to start monitoring. In certain embodiments, the command to cease monitoring could be automatically triggered within the device if a predefined condition is met, such as a monitoring timer expiring or a specific error threshold being reached.

In still more embodiments, the process 800 can receive command to transmit count data (block 860). This command may instruct the network device to send out the accumulated count statistics for the marked packets that were observed. In some embodiments, the command might specify the destination for the data, such as the IP address and port of a telemetry collector or a network management server. In various embodiments, this command could be part of a regular polling cycle where a management system periodically requests data from multiple network devices.

In yet further embodiments, the process 800 can transmit count data to the requesting device (block 870). This operation involves the network device sending the collected packet counts to the entity that requested them. In some embodiments, the count data can be formatted according to a standard telemetry protocol, such as gRPC, NetConf, or SNMP, for transmission. In certain embodiments, the transmitted data might include additional contextual information along with the raw counts, such as timestamps for the monitoring period, device identifiers, and specific interface identifiers where the marked packets were observed.

Although a specific embodiment for a process for a network device handling packet monitoring and data reporting is discussed with respect to FIG. 8, any of a variety of systems and/or devices may be utilized to carry out the operations in accordance with various embodiments. For example, the process 800 may be executed by the firmware or embedded software operating on a network switch, router, or a dedicated monitoring probe. The elements and operations depicted in FIG. 8 may also be interchangeable with other elements or operations of FIG. 1-7 and FIG. 9 as required to realize a particularly desired embodiment.

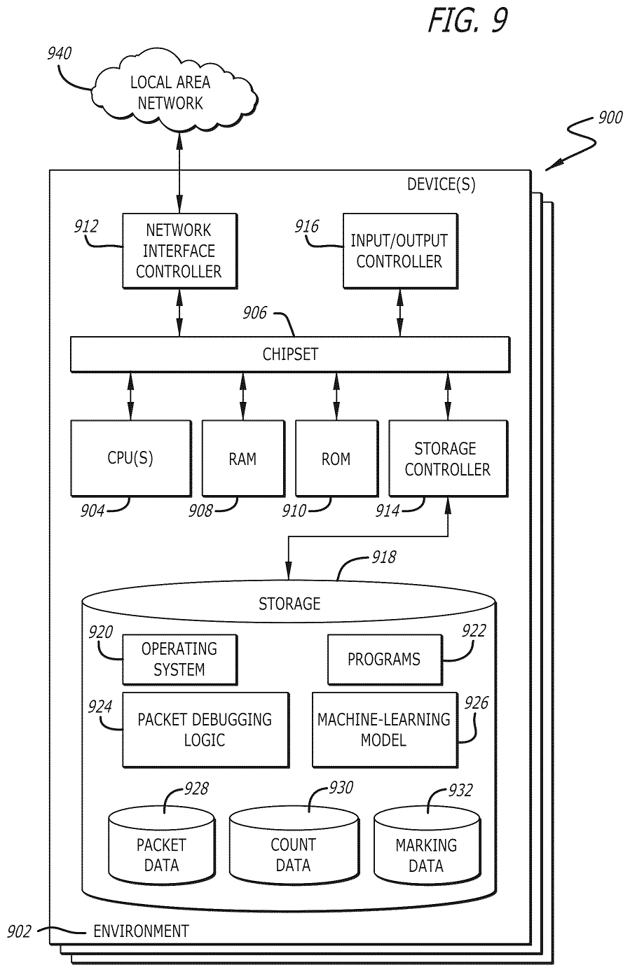

Referring to FIG. 9, a conceptual block diagram of a device 900 suitable for configuration with a packet debugging logic, in accordance with various embodiments of the disclosure is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the local area network (LAN 940). The chipset 906 can include functionality for providing network connectivity through a network interface controller (“NIC”) 912, which may comprise a gigabit Ethernet adapter or similar component. The NIC 912 can be capable of connecting the device 900 to other devices over the LAN 940 or other networks. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, packet debugging logic 924, machine-learning model 926, packet data 928, count data 930, and marking data 932, which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through various interfaces such as serial attached SCSI (“SAS”), serial advanced technology attachment (“SATA”), fiber channel (“FC”), or other types of interfaces for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like. For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated that computer-readable storage media is any available media that provides for the non-transitory storage of data and that can be accessed by the device 900. By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to various embodiments, the operating system can comprise LINUX, WINDOWS® SERVER, UNIX, or other suitable operating systems. The storage 918 can store other systems or applications 922 and data utilized by the device 900. In various embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as applications 922 or specific logic modules and transform the device 900 by specifying how the processor(s) 904 can transition between states, as described above.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, can include other components that are not explicitly shown, or might utilize an architecture completely different than that shown.

In many embodiments, the device 900 can include packet debugging logic 924. This logic 924 can comprise computer-executable instructions stored in memory (such as storage 918 or RAM 908) and executed by the processor(s) 904 to perform operations related to identifying and diagnosing packet loss within a data network or a monitored segment thereof. In various embodiments, the packet debugging logic 924 can be configured to determine a segment of a data network to monitor, initiate the monitoring process perhaps by interacting with network nodes via the NIC 912, and manage the marking of packets for specific data flows within that segment. The logic 924 may coordinate the start and stop times for observation periods, potentially using timers or receiving external commands.

Furthermore, the packet debugging logic 924 can be configured to receive count data from various network nodes involved in the monitoring. This received data, potentially stored temporarily in RAM 908 or persistently in storage 918 as count data 930, can then be processed and analyzed by the packet debugging logic 924. In certain embodiments, this analysis involves identifying mismatches by comparing ingress and egress packet counts associated with the marked flow at different points in the network. Based on these identified mismatches, the packet debugging logic 924 can determine a potential location of packet loss, such as identifying a problematic network node or link. In some embodiments, the packet debugging logic 924 may also generate notifications or reports detailing the findings, or potentially trigger automated remedial actions.

In some embodiments, the packet debugging logic 924 may interact with other components stored in storage 918, such as using packet data 928 to inform the selection of flows to monitor or marking techniques, using marking data 932 to retrieve parameters for marking or ACL configuration, processing count data 930 for its core analysis, and potentially leveraging a machine-learning model 926 to enhance its diagnostic capabilities, for instance, by predicting likely failure points or interpreting complex patterns in the count data. The packet debugging logic 924 may effectively orchestrates the diagnostic process described in various embodiments herein.

In a number of embodiments, the storage 918 can include packet data 928. Packet data 928 can contain information related to network packets and data flows relevant to the packet loss debugging process. In some embodiments, packet data 928 might store definitions or specifications of data flows to be monitored, including criteria like source/destination IP addresses, port numbers, and protocol types. In certain embodiments, packet data 928 could contain sampled packet headers captured from the network, which might be analyzed by the packet debugging logic 924 to understand traffic patterns or determine suitable fields for packet marking.

Furthermore, in various embodiments, packet data 928 may store metadata associated with ongoing or historical monitoring sessions. In various embodiments, this could include information about which flows were monitored, during which time periods, and potentially baseline performance characteristics for those flows. This historical data might be used for comparison purposes or as input for analysis or machine learning models aimed at predicting future network behavior or potential issues. Packet data 928 serves as an input and potentially an output repository for information directly related to the network traffic being scrutinized.

In still more embodiments, the storage 918 can include count data 930. This count data 930 can be primarily configured to store the quantitative results collected from network nodes during a monitoring observation period. In many embodiments, count data 930 comprises the ingress and egress packet counts for marked packets, received from the plurality of network nodes participating in the monitoring of a specific data flow. These counts might be stored along with associated metadata, such as the identity of the network node, the specific interface (ingress or egress port), timestamps indicating the collection interval, and identifiers for the monitored data flow.

The packet debugging logic 924 can utilize the count data 930 for its analysis. In certain embodiments, the logic 924 accesses this data to perform comparisons between ingress and egress counts at individual nodes, or between counts at adjacent nodes, to identify the mismatches indicative of packet loss. Count data 930 may also store aggregated statistics or historical count information, which could be used to establish baseline behaviors or detect deviations over time. The structure and format of count data 930 can be optimized for efficient querying and analysis by the packet debugging logic 924.

In still more embodiments, the storage 918 can include marking data 932. This may contain configuration details and parameters related to the packet marking techniques employed in the diagnostic process. In some embodiments, marking data 932 may specify the chosen marking methodology, such as which specific bits within which packet headers (e.g., IP fragment field, RoCEv2 reserved bits, VxLAN flags) are designated as markers. It could also store the specific patterns or values used to signify a marked packet.

Furthermore, marking data 932 might store information used by the packet debugging logic 924 or transmitted to network nodes to configure marking behavior. In certain embodiments, this could include the duration for which marking should be active, parameters for selecting packets belonging to the target data flow, or mappings between different potential marking schemes and network device capabilities. Essentially, marking data 932 acts as a repository for the “how-to” information regarding the packet marking aspect of the monitoring process, ensuring consistency and correct identification of marked packets throughout the monitored segment.

Finally, in many embodiments, data may be processed into a format usable by a machine-learning model 926 (e.g., feature vectors), and or other pre-processing techniques may be applied. The machine-learning (“ML”) model 926 may be any type of ML model, such as supervised models, reinforcement models, and/or unsupervised models, including but not limited to linear regression models, logistic regression models, decision trees, Naïve Bayes models, neural networks, k-means cluster models, random forest models, and/or other types of ML models. In the context of packet debugging, the ML model 926 may be configured to analyze patterns in historical or real-time network data, potentially including packet data 928 and count data 930, to enhance the diagnostic process.

In some embodiments, the ML model 926 might be trained to predict likely locations of packet loss based on network topology, current traffic conditions, historical failure data, or subtle anomalies detected in the count data 930 that might not be obvious through simple comparison. In certain embodiments, the ML model 926 could assist the packet debugging logic 924 in optimizing the monitoring strategy, for instance, by suggesting which data flows or network segments are most critical or most likely to experience issues, thereby focusing diagnostic efforts more effectively. Furthermore, the ML model 926 could potentially be used to suggest appropriate remedial actions based on the nature and location of the determined packet loss, learning from the effectiveness of past remediation attempts.

Although a specific embodiment for a device 900 capable of executing components and logic is discussed with respect to FIG. 9, any of a variety of systems and/or architectures may be utilized in accordance with various embodiments. For example, the device 900 could be implemented as a dedicated network appliance, a server hosting network management software, or integrated into the control plane of a high-capacity network switch or router. The elements depicted in FIG. 9 may also be interchangeable with other elements or represent components distributed across multiple devices, and may interoperate with elements or processes illustrated in FIG. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a packet debugging logic that is configured to:
determine a segment of a data network to monitor packet loss;
initiate monitoring of the segment;
mark a plurality of packets of a data flow within the segment;
receive count data associated with one or more packets traversing within the segment;
identify mismatches within the count data; and
determine a packet loss based on the identified mismatches.

2. The device of claim 1, wherein the plurality of packets are marked at an ingress point of a monitored segment of a data network.

3. The device of claim 2, wherein the segment of a data network comprises a plurality of network nodes.

4. The device of claim 3, wherein the ingress point is associated with a first network node of the plurality of network nodes.

5. The device of claim 4, wherein the count data is associated with a packet counting process that occurs at each of the plurality of network nodes.

6. The device of claim 5, wherein the count data is received from at least one of the plurality of network nodes.

7. The device of claim 6, wherein the count data comprises:
values associated with the marked packets traversing into an ingress point of a network node; and
values associated with the marked packets traversing out of an egress point of a network node.

8. The device of claim 7, wherein identifying mismatches comprises at least comparing the values associated with the marked packets traversing into an ingress point of a network node against the values associated with the marked packets traversing out of an egress point of a network node.

9. The device of claim 1, wherein the marking occurs during a predefined observation period.

10. The device of claim 1, wherein determining the packet loss comprises at least identifying a problematic node within the segment of the data network.

11. The device of claim 10, further comprising generating, upon determination of a mismatch, a notification configured to elicit at least one remedial action.

12. A device, comprising:
a processor; and
a memory communicatively coupled to the processor, wherein the memory comprises a packet debugging logic that is configured to:
receive a first command from an external device to monitor network traffic;
determine a presence of one or more marked packets;
count the one or more marked packets;
generate count data based on at least the counted one or more marked packets; and
transmit the count data to the external device.

13. The device of claim 12, wherein monitoring the network traffic includes monitoring packets at one or more ingress ports of the device.

14. The device of claim 13, wherein monitoring the network traffic further includes monitoring packets at one or more egress ports of the device.

15. The device of claim 14, wherein determining the presence of one or more marked packets includes at least examining contents of a header of a packet.

16. The device of claim 12 wherein the device is further configured to receive a second command during counting to cease monitoring of network traffic.

17. The device of claim 12, wherein the first command comprises at least an indication of a type of marked packet to count.

18. The device of claim 12, wherein the first command comprises at least a predetermined period of time to count.

19. The device of claim 18 wherein the device is further configured to cease monitoring network traffic upon expiration of the predetermined period of time.

20. A method for determining packet loss comprising:
determining a segment of a data network to monitor packet loss;
initiating monitoring of the segment;
marking a plurality of packets of a data flow within the segment;
receiving count data associated with one or more packets traversing within the segment;
identifying mismatches within the count data; and
determining a packet loss based on an identified mismatch.
